(19) United States
(12) Patent Application Publication
(10) Pub. No.: US 2019/0324729 A1
(43) Pub. Date: Oct. 24, 2019

(54) Web Application Development Using a Web Component Framework

(71) Applicant: Microsoft Technology Licensing, LLC, Redmond, WA (US)

(72) Inventor: Rajendra Prasad BADAPANDA, Redmond, WA (US)

(73) Assignee: Microsoft Technology Licensing, LLC, Redmond, WA (US)

(21) Appl. No.: 15/961,023

(22) Filed: Apr. 24, 2018

(51) Int. Cl. G06F 8/36; G06F 11/36

(52) U.S. Cl. CPC G06F 8/36; G06F 11/362

(57) ABSTRACT

Described herein is a system and method for generating computer code for a web application. A user selection of one of a plurality of components from a library of components for building web applications is received. Each component comprises atomic code having a user interface portion coded using a first library (e.g., the React JavaScript library), a state management portion coded using a second library (e.g., the Redux JavaScript library), and, a controller portion coded using a third library (e.g., Redux observable middleware). User input customizing the selected component is received. Computer code for the web application in accordance with the received user input customizing the selected component is then stored.

### BACKGROUND

A web application is an application that is accessible over a network (e.g., the Internet or an intranet). A web application may be hosted in a browser-controlled environment or coded in a browser-supported language with the application relying on a web browser to execute. Web applications are popular because of the ever increasing utilization of the Internet in many aspects of daily living. Depending upon the functional requirements of a particular web application, coding, debugging and testing of the particular web application can take a significant amount of time.

### SUMMARY

Described herein is a system for generating computer code for a web application, comprising: a processing system comprising a processor and a memory having computer-executable instructions stored thereupon which, when executed by the processor, cause the processing system to: receive a user selection of one of a plurality of components from a library of components for building web applications, each component comprising atomic code having a user interface portion coded using a first library, a state management portion coded using a second library, and, a controller portion coded using a third library; receive user input customizing the selected component; and store computer code for the web application in accordance with the received user input customizing the selected component.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for generating computer code for a web application.

FIG. 2 is a functional block diagram that illustrates a system for generating a component.

FIG. 3 is a flow chart that illustrates a method of generating a web application.

FIG. 4 is a flow chart that illustrates another method of generating a web application.

FIG. 5 is a flow chart that illustrates a method of generating a component.

FIG. 6 is a functional block diagram that illustrates an exemplary computing system.

### DETAILED DESCRIPTION

Various technologies pertaining to generating of a web application using a framework having a library of atomic components for building web application are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding generating a web application. What follows are one or more exemplary systems and methods.

Aspects of the subject disclosure pertain to the technical problem of generating a web application. The technical features associated with addressing this problem involve receiving a user selection of one of a plurality of components from a library of components for building web applications, each component comprising atomic code having a user interface portion coded using a first library, a state management portion coded using a second library, and, a controller portion coded using a third library; receiving user input customizing the selected component; and, storing computer code for the web application in accordance with the received user input customizing the selected component. Accordingly, aspects of these technical features exhibit technical effects of more efficiently and effectively generating web applications, for example, reducing computer resource consumption and/or development time.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

Web application(s) have generally been developed from scratch for a specific purpose. Debugging of web applications has thus been frustrating since any code of the application is a potential source of coding error(s). Additionally, in some embodiments, code library(ies) that are beneficial for coding a particular aspect of the web application (e.g., user interface, state management, control, etc.) may be unsuitable for coding another aspect of the web application.

Described herein are systems and methods in which web applications are built using a library of components which serve as building blocks. In some embodiments, each of the components have been tested and debugged before inclusion in the library of components. In some embodiments, each of the components is a self-contained (e.g., atomic) portion of code that performs a particular function. In some embodiments, each of the components includes a user interface portion, a state management portion and a controller portion, with each portion coded in a different JavaScript library specifically suited to that particular portion. Thus, in some embodiments, custom web applications can be built in a fraction of time when compared with custom-coding of a web application using conventional methods. Additionally, substantially less time can be spent debugging/testing the web application built using the library of components, as described herein.

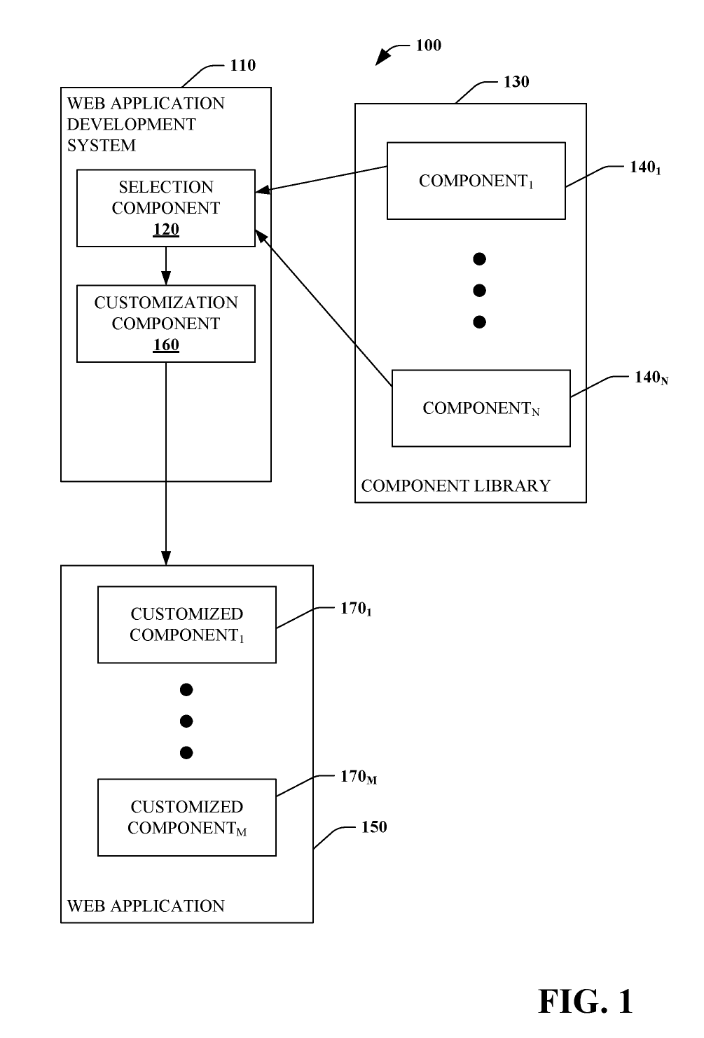

Referring to FIG. 1, a system for generating computer code for a web application 100 is illustrated. The system 100 utilizes a library of components that serve as building blocks for web application(s). In some embodiments, each component is a self-contained package of code that performs particular function(s). In some embodiments, the component(s) are tested and debugged prior to inclusion in the library of components. Thus, in some embodiments, debugging of web application(s) built using the components can be limited to user-specified interaction(s) between components and/or user-configurable customization(s) of the components.

The system 100 includes a web application development system 110 that provides a development environment for a user (e.g., web application developer) to create a web application. The web application development system 110 includes a selection component 120 that receives a user selection of one of a plurality of components 140 from a component library 130 (e.g., for building web applications). In some embodiments, each of the components 140 are based on a model-view-controller architectural pattern. In some embodiments, a first library is used for the model portion of the component 140, a different second library is used for the view portion of the component 140 and a third different library is used for the controller portion 140.

In some embodiments, each component 140 of the component library 130 is a self-contained package (e.g., atomic portion of code) having a user interface portion, a state management portion and a controller (e.g., coordination) portion. The user interface portion is responsible for generating at least a part of the user interface for the web application. In some embodiments, the user interface portion is coded using a first JavaScript library, for example, React (e.g., view coded in React). React is a JavaScript library for building use interfaces which allows developers to create web-applications that use data and change over time without reloading the page. In some embodiments, React is not used to manage internal state and/or control of the component 140

In some embodiments, the state management portion is coded using a second JavaScript second library, for example, Redux (e.g., model coded in Redux). Redux is a JavaScript library designed for managing application state. As such, Redux is a state container for JavaScript applications. In some embodiments, Redux is not used to generate the user interface and/or control portions of the component 140. In some embodiments, selector(s) are used for derived state information. For example, selector(s) can take state and transform the state into view-friendly data structure(s). In some embodiments, state is treated as a client-side database.

In some embodiments, the controller portion is coded using a third JavaScript library, for example, Redux-observable which is the JavaScript (RxJS) middleware for Redux (e.g., controller coded in Redux-observable). RxJS is a JavaScript library for reactive programming asynchronous or callback-based code. In some embodiments, Redux-observable is not used to generate the user interface and/or state management portions of the component 140.

The coordination portion can facilitate communication with a user of the web application, coordination between the user interface portion and the state management portion, and/or communication between the component and another component of the web application 150.

The web application development system 110 further includes a customization component 160 that receives user input for customizing a selected component 140. By way of explanation and not limitation, the customization can include appearance of a user interface and/or elements of the user interface), content of the user interface (e.g., number of in a list) and/or elements of the user interface, action(s) taken in response to selection of a particular element of the user interface, and/or communication between the component and another component. The customized selected component can be stored within the web application 150 as a customized component 170.

The web application 150 can have one or a plurality of customized components 170 with the user specifying interaction(s) between the customized components 170, if any, using the customization component 160. In some embodiments, since the web application 150 is built from a plurality of components 140 which have each been debugged and tested, time spent debugging and/or testing the web application 150 can be drastically reduced. In some embodiments, only user customization(s) and user-specified interaction(s) between the customized components 170 require debugging and/or testing.

In some embodiments, a component developer can perform one or more of the following. First, identify a slice of state which is needed for the component. In some embodiments, an intent is to limit it to the smallest set needed for the component. Second, a Redux code file (e.g., called duck.js) is created which contains action type(s), action creator(s) and implements the reducer containing the state change logic—limited only to the set identified in the first step. Third, a user interface is created in React which uses the slice of state created by the reducers created in the second step. For example, react-redux connect library and selectors can be utilized. Fourth, an Epic (e.g., a function provided by for redux-observables/RXJS) is created, to talk to other component(s).

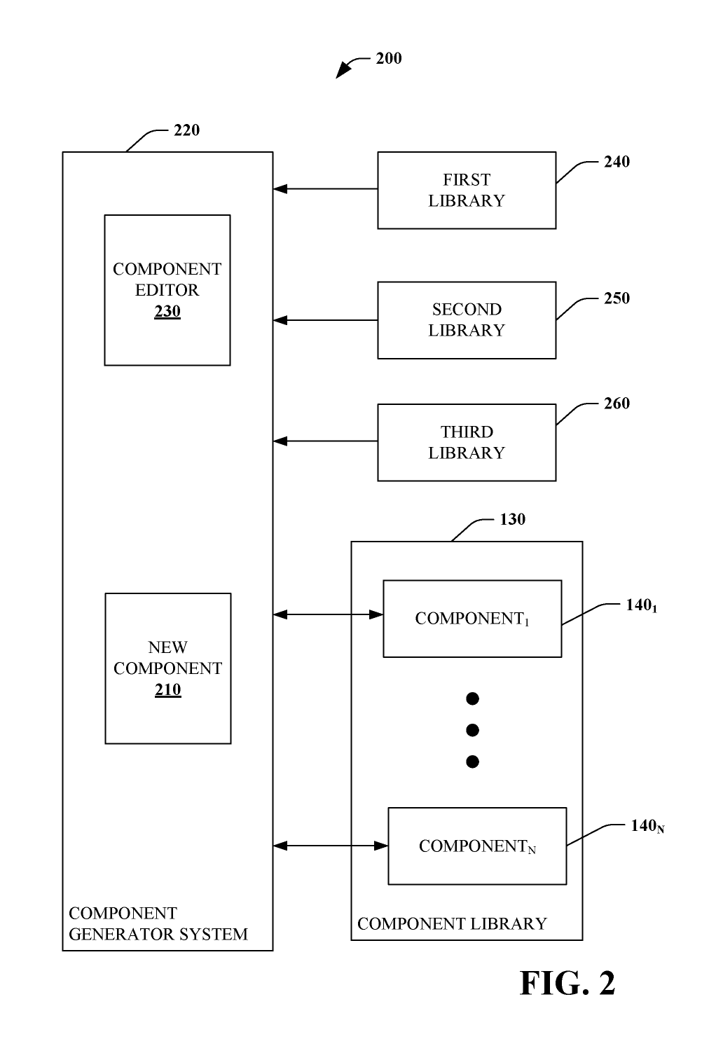

Turning to FIG. 2, a system for generating a component 200 is illustrated. The system 200 can be used, for example, by a developer to create a new component 210 for building web application(s). The system 200 includes a component generator system 220 having a component editor 230 that provides a user interface for a user (e.g., developer) to create the new component 210 from scratch and/or based upon another component 140 stored in the component library 130.

In some embodiments, each component includes a user interface portion, a statement management portion and a controller (e.g., coordination) portion, as discussed above. Using the component editor 230, the user is able to access a first library 240, for example, the React JavaScript library to code the view portion of the new component 210. The user is further able to access a second library 250, for example, the Redux is a JavaScript library to code the state management portion of the new component 210. The user is also able to access a third library 260, for example, the Redux-observable which is the RxJS middleware for Redux to code the controller portion of the new component 210.

Once the user has created code for the new component 210 (and optionally, debugged and/or tested the component 140), the new component 210 can be saved as a component 140 in the component library 130.

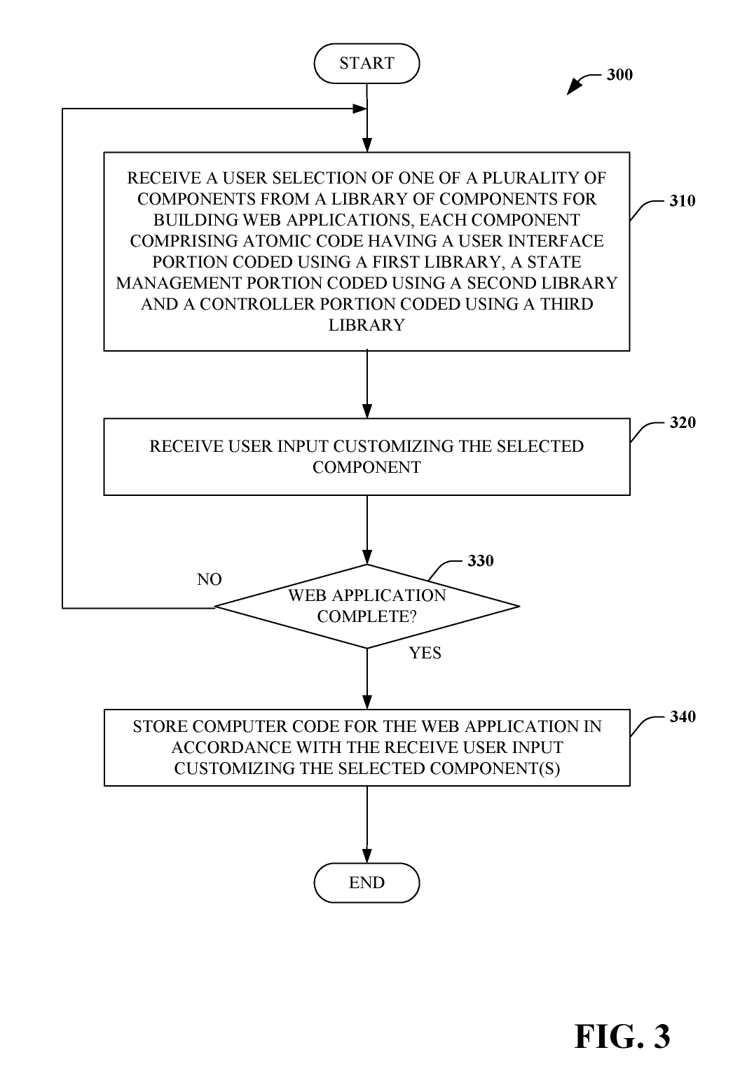

FIGS. 3-5 illustrate exemplary methodologies relating to generating a web application using components. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 3, a method of generating a web application 300 is illustrated. In some embodiments, the method 300 is performed by the system 100.

At 310, a user selection of one of a plurality of components from a library of components for building web applications is received. Each components comprises atomic code (e.g., a self-contained package) having a user interface portion coded using a first library (e.g., view coded using React JavaScript library), a state management portion coded using a second library (e.g., model coded using Redux JavaScript library) and, a controller portion coded using a third library (e.g., controller coded using Redux-observable).

At 320, user input customizing the selected component is received. At 330, a determination is made as to whether the web application is completed. If the determination at 330 is NO, processing continues at 310. If the determination at 330 is YES, at 340, computer code for the web application is stored in accordance with the receive user input customizing the selected component(s) and, optionally, interaction(s) between the components.

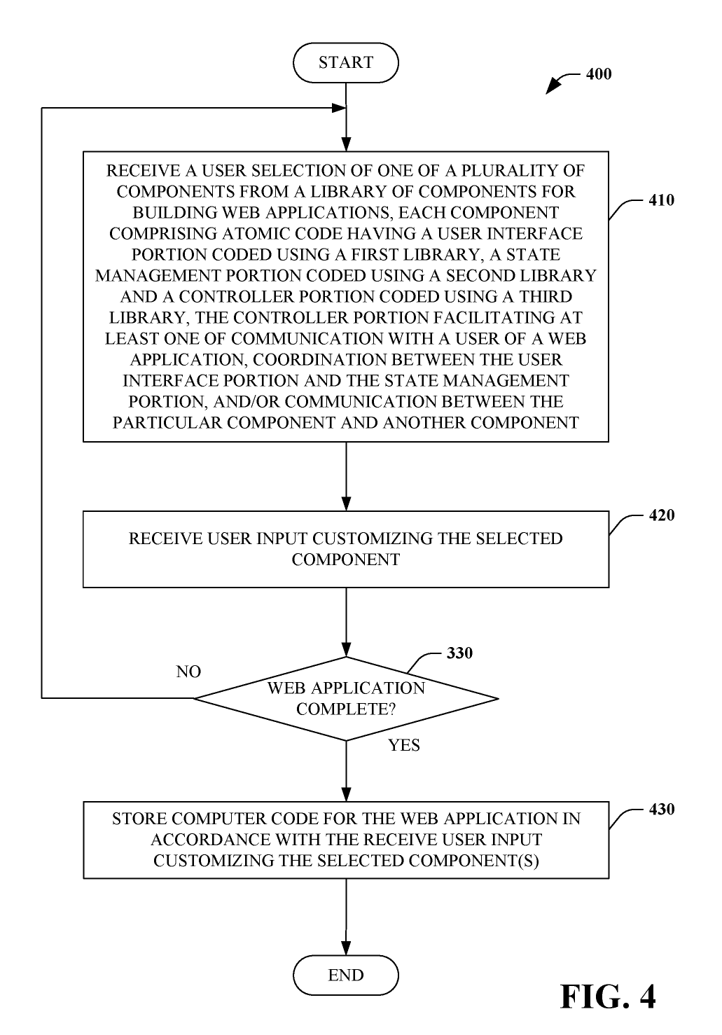

Referring to FIG. 4, a method of generating a web application 300 is illustrated. In some embodiments, the method 400 is performed by the system 100.

At 410, a user selection of one of a plurality of components from a library of components for building web applications is received. Each components comprises atomic code (e.g., a self-contained package) having a user interface portion coded using a first library (e.g., view coded using React JavaScript library), a state management portion coded using a second library (e.g., model coded using Redux JavaScript library) and, a controller portion coded using a third library (e.g., controller coded using Redux-observable). The controller portion facilitates at least one of communication with a user of the web application, coordination between the user interface portion and the state management portion, and/or communication between the particular component and another component.

In some embodiments, the controller portion does not communicate directly with the user of the web application as direct communication is performed via the user interface portion. However, the controller portion can fetch data from a network for the user, the code for which can be written by the application developer.

At 420, user input customizing the selected component is received. At 430, a determination is made as to whether the web application is completed. If the determination at 430 is NO, processing continues at 410. If the determination at 430 is YES, at 440, computer code for the web application is stored in accordance with the receive user input customizing the selected component(s) and, optionally, interaction(s) between the components.

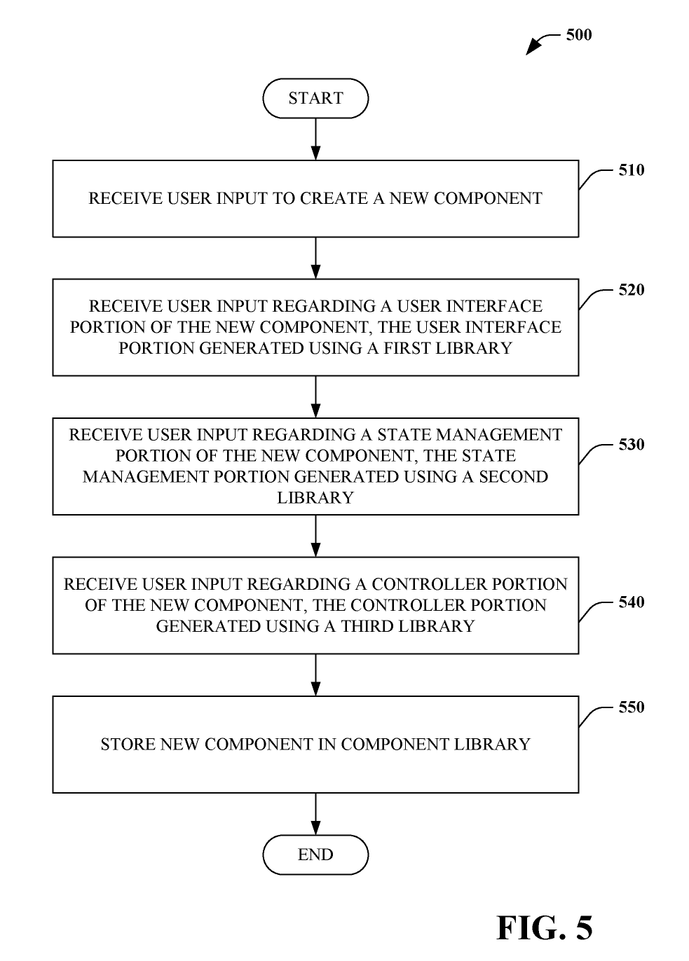

Turning to FIG. 5, a method of generating a component 500 is illustrated. In some embodiments, the method 500 is performed by the system 200.

At 510, user input to create a new component is received. At 520, user input regarding a user interface of the new component is received. The user interface portion is generated using a first library (e.g., view coded using React JavaScript library). At 530, user input regarding a state management portion of the new component is received. The state management portion of the new component is generated using a second library (e.g., model coded using Redux JavaScript library). At 540, user input regarding a controller portion of the new component is received. The controller portion is generated using a third library (e.g., controller coded using Redux-observable). At 550, the new component is stored in a component library, for example, for use in generating a web application.

Described herein is a system for generating computer code for a web application, comprising: a processing system comprising a processor and a memory having computer-executable instructions stored thereupon which, when executed by the processor, cause the processing system to: receive a user selection of one of a plurality of components from a library of components for building web applications, each component comprising atomic code having a user interface portion coded using a first library, a state management portion coded using a second library, and, a controller portion coded using a third library; receive user input customizing the selected component; and store computer code for the web application in accordance with the received user input customizing the selected component.

The system can include wherein the user interface portion facilitates direct communication with a user of the web application. The system can further include wherein the controller portion facilitates coordination between the user interface portion and the state management portion. The system can include wherein the controller portion facilitates communication between the component and another component.

The system can further include wherein the first library is the React JavaScript library. The system can include wherein the second library is the Redux JavaScript library. The system can further include wherein the third library is based on the Redux observable middleware.

The system can include the memory having further computer-executable instructions stored thereupon which, when executed by the processor, cause the processing system to: receive a user selection of another one of the plurality of components from the library of components for building web applications; and receive user input customizing the selected another component,

wherein computer code for the web application is further stored in accordance with the received user input customizing the selected another component. The system can further include the memory having further computer-executable instructions stored thereupon which, when executed by the processor, cause the processing system to: debug the web application comprising debugging only code generated in response to the user input customizing the selected component.

Described herein is a method of generating a web application, comprising: receiving a user selection of one of a plurality of components from a library of components for building web applications, each component comprising atomic code having a user interface portion coded using a first library, a state management portion coded using a second library, and, a controller portion coded using a third library; receiving user input customizing the selected component; and storing computer code for the web application in accordance with the received user input customizing the selected component. The method can include wherein the controller portion facilitates at least one of communication with a user of the web application, coordination between the user interface portion and the state management portion, or communication between the component and another component.

The method can further include wherein the first library is based on the React JavaScript library. The method can further include wherein the second library is the Redux JavaScript library. The method can further include wherein the third library is the Redux observable middleware.

The method can further include receiving a user selection of another one of the plurality of components from the library of components for building web applications; and receiving user input customizing the selected another component, wherein computer code for the web application is further stored in accordance with the received user input customizing the selected another component. The method can further include debugging only code generated in response to the user input customizing the selected component.

Described herein is a computer storage media storing computer-readable instructions that when executed cause a computing device to: receive a user selection of one of a plurality of components from a library of components for building web applications, each component comprising atomic code having a user interface portion coded using a first library, a state management portion coded using a second library, and, a controller portion coded using a third library; receive user input customizing the selected component; and store computer code for the web application in accordance with the received user input customizing the selected component.

The computer storage media can further include wherein the controller portion facilitates at least one of communication with a user of the web application, coordination between the user interface portion and the state management portion, or communication between the component and another component. The computer storage media can further include wherein the first library is the React JavaScript library, the second library is the Redux JavaScript library, and, the third library is based on the Redux observable middleware. The computer storage media can store further computer-readable instructions that when executed cause a computing device to: receive a user selection of another one of the plurality of components from the library of components for building web applications; and receive user input customizing the selected another component, wherein computer code for the web application is further stored in accordance with the received user input customizing the selected another component.

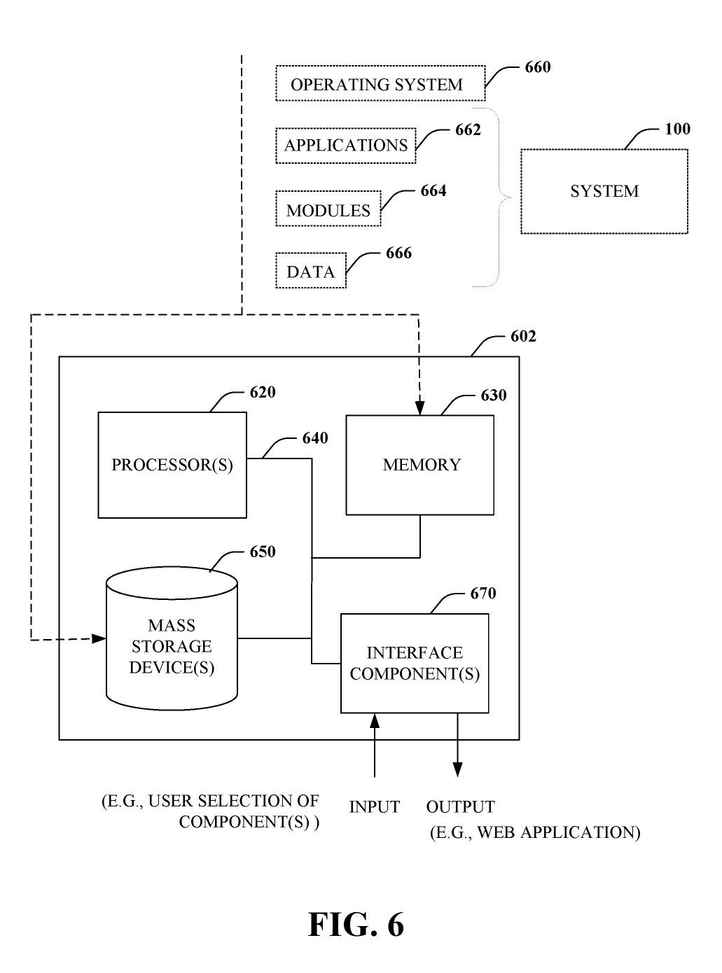

With reference to FIG. 6, illustrated is an example general-purpose processing system, computer or computing device 602 (e.g., mobile phone, desktop, laptop, tablet, watch, server, hand-held, programmable consumer or industrial electronics, set-top box, game system, compute node, etc.). For instance, the computing device 602 may be used in a system for generating computer code for a web application 100 and/or a system for generating a component 200.

The computer 602 includes one or more processor(s) 620, memory 630, system bus 640, mass storage device(s) 650, and one or more interface components 670. The system bus 640 communicatively couples at least the above system constituents. However, it is to be appreciated that in its simplest form the computer 602 can include one or more processors 620 coupled to memory 630 that execute various computer executable actions, instructions, and or components stored in memory 630. The instructions may be, for instance, instructions for implementing functionality described as being carried out by one or more components discussed above or instructions for implementing one or more of the methods described above.

The processor(s) 620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 620 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 620 can be a graphics processor.

The computer 602 can include or otherwise interact with a variety of computer-readable media to facilitate control of the computer 602 to implement one or more aspects of the claimed subject matter. The computer-readable media can be any available media that can be accessed by the computer 602 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 602. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 630 and mass storage device(s) 650 are examples of computer-readable storage media. Depending on the exact configuration and type of computing device, memory 630 may be volatile (e.g., RAM), non-volatile (e.g., ROM, flash memory, etc.) or some combination of the two. By way of example, the basic input/output system (BIOS), including basic routines to transfer information between elements within the computer 602, such as during start-up, can be stored in nonvolatile memory, while volatile memory can act as external cache memory to facilitate processing by the processor(s) 620, among other things.

Mass storage device(s) 650 includes removable/non-removable, volatile/non-volatile computer storage media for storage of large amounts of data relative to the memory 630. For example, mass storage device(s) 650 includes, but is not limited to, one or more devices such as a magnetic or optical disk drive, floppy disk drive, flash memory, solid-state drive, or memory stick.

Memory 630 and mass storage device(s) 650 can include, or have stored therein, operating system 660, one or more applications 662, one or more program modules 664, and data 666. The operating system 660 acts to control and allocate resources of the computer 602. Applications 662 include one or both of system and application software and can exploit management of resources by the operating system 660 through program modules 664 and data 666 stored in memory 630 and/or mass storage device (s) 650 to perform one or more actions. Accordingly, applications 662 can turn a general-purpose computer 602 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 662, and include one or more modules 664 and data 666 stored in memory and/or mass storage device(s) 650 whose functionality can be realized when executed by one or more processor(s) 620.

In accordance with one particular embodiment, the processor(s) 620 can correspond to a system on a chip (SOC) or like architecture including, or in other words integrating, both hardware and software on a single integrated circuit substrate. Here, the processor(s) 620 can include one or more processors as well as memory at least similar to processor(s) 620 and memory 630, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 602 also includes one or more interface components 670 that are communicatively coupled to the system bus 640 and facilitate interaction with the computer 602. By way of example, the interface component 670 can be a port (e.g., serial, parallel, PCMCIA, USB, FireWire, etc.) or an interface card (e.g., sound, video, etc.) or the like. In one example implementation, the interface component 670 can be embodied as a user input/output interface to enable a user to enter commands and information into the computer 602, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 670 can be embodied as an output peripheral interface to supply output to displays (e.g., LCD, LED, plasma, etc.), speakers, printers, and/or other computers, among other things. Still further yet, the interface component 670 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

1. A system for generating computer code for a web application, comprising:
a processing system comprising a processor and a memory having computer-executable instructions stored thereupon which, when executed by the processor, cause the processing system to:
receive a user selection of one of a plurality of components from a library of self-contained components for building web applications, each component comprising atomic code having a user interface portion coded using a first library, a state management portion coded using a second library, and, a controller portion coded using a third library;
receive user input customizing the selected component; and
store computer code for the web application in accordance with the received user input customizing the selected component.

2. The system of claim 1, wherein the user interface portion facilitates direct communication with a user of the web application.

3. The system of claim 1, wherein the controller portion facilitates coordination between the user interface portion and the state management portion.

4. The system of claim 1, wherein the controller portion facilitates communication between the component and another component.

5. The system of claim 1, wherein the first library is the React JavaScript library.

6. The system of claim 1, wherein the second library is the Redux JavaScript library.

7. The system of claim 1, wherein the third library is based on the Redux observable middleware.

8. The system of claim 1, the memory having further computer-executable instructions stored thereupon which, when executed by the processor, cause the processing system to:
receive a user selection of another one of the plurality of components from the library of components for building web applications; and
receive user input customizing the selected another component, wherein computer code for the web application is further stored in accordance with the received user input customizing the selected another component.

9. The system of claim 1, the memory having further computer-executable instructions stored thereupon which, when executed by the processor, cause the processing system to:
debug the web application comprising debugging only code generated in response to the user input customizing the selected component.

10. A method of generating a web application, comprising:
receiving a user selection of one of a plurality of components from a library of self-contained components for building web applications, each component comprising atomic code having a user interface portion coded using a first library, a state management portion coded using a second library, and, a controller portion coded using a third library;
receiving user input customizing the selected component; and
storing computer code for the web application in accordance with the received user input customizing the selected component.

11. The method of claim 10, wherein the controller portion facilitates at least one of communication with a user of the web application, coordination between the user interface portion and the state management portion, or communication between the component and another component.

12. The method of claim 10, wherein the first library is based on the React JavaScript library.

13. The method of claim 10, wherein the second library is the Redux JavaScript library.

14. The method of claim 10, wherein the third library is the Redux observable middleware.

15. The method of claim 10, further comprising:
receiving a user selection of another one of the plurality of components from the library of components for building web applications; and
receiving user input customizing the selected another component, wherein computer code for the web application is further stored in accordance with the received user input customizing the selected another component.

16. The method of claim 10, further comprising:
debugging only code generated in response to the user input customizing the selected component.

17. A computer storage media storing computer-readable instructions that when executed cause a computing device to:
receive a user selection of one of a plurality of components from a library of self-contained components for building web applications, each component comprising atomic code having a user interface portion coded using a first library, a state management portion coded using a second library, and, a controller portion coded using a third library;
receive user input customizing the selected component; and
store computer code for the web application in accordance with the received user input customizing the selected component.

18. The computer storage media of claim 17, wherein the controller portion facilitates at least one of communication with a user of the web application, coordination between the user interface portion and the state management portion, or communication between the component and another component.

19. The computer storage media of claim 18, wherein the first library is the React JavaScript library, the second library is the Redux JavaScript library, and, the third library is based on the Redux observable middleware.

20. The computer storage media of claim 18 storing further computer-readable instructions that when executed cause a computing device to:
receive a user selection of another one of the plurality of components from the library of components for building web applications; and
receive user input customizing the selected another component, wherein computer code for the web application is further stored in accordance with the received user input customizing the selected another component.
